(19) United States
(12) Patent Application Publication
(10) Pub. No.: US 2009/0049172 A1
(43) Pub. Date: Feb. 19, 2009

(54) Concurrent Node Self-Start in a Peer Cluster

(76) Inventors: Robert Miller, Rochester, MN (US); Steven James Reinartz, Rochester, MN (US); Kiswanto Thayib, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/839,577

(22) Filed: Aug. 16, 2007

(51) Int. Cl. G06F 15/173

(52) U.S. Cl. 709/225

(57) ABSTRACT

A method and apparatus for joining a plurality of nodes to a cluster. Each node in the cluster maintains a respective membership list identifying each active member node of the cluster. Membership change messaging is managed relative to multiple concurrent start requests to ensure that a first node is added to the respective membership lists before broadcasting a membership change message (MCM) in response to which, the nodes of the cluster, inclusive of the first node, add the second node to the respective membership lists.

### BACKGROUND OF THE INVENTION

1. Field of the Invention

The field of the invention relates generally to computer clusters, specifically to concurrent nodes self-starting in a peer cluster.

2. Description of the Related Art

Clustering generally refers to a computer system organization where multiple computers or nodes are networked together to cooperatively perform computer tasks. An important aspect of a computer cluster is that all of the nodes in the cluster present a single system image—that is, from the perspective of a user and from the nodes themselves, the nodes in a cluster appear collectively as a single computer entity.

A peer cluster is characterized by a decentralized store of cluster information. In a peer cluster, each node maintains its own perspective of the cluster. Maintaining a uniform view of the cluster across each member node is critical to maintaining the single system image.

Node self-start is a process whereby an automated script on a node invokes clustering on the node itself, which may be necessary as a result of planned or unplanned outages (such as node maintenance, or after node failure). Node self-start involves node discovery, in which the starting node attempts to find another active cluster node to join with, known as a sponsor node.

A concurrent node self-start is multiple nodes self-starting simultaneously, such as when multiple logical partitions in the same cluster are powered on. As each node is started, the starting node has to know about the other nodes that are starting at the same time. If not, some starting nodes are not aware of each other, and there is no single system image. Having more than one sponsor is problematic because each sponsor is trying to start a node at the same time as the other sponsors. Accordingly, it is likely that some nodes are not aware of other nodes starting at the same time.

Having a single sponsor node eliminates this problem because the single sponsor serializes the start requests, ensuring that each node is aware of all other nodes starting at the same time. However, limiting the sponsor to one node for large clusters implicates costly delays. Accordingly, there is a need for a concurrent node self-start in a peer cluster.

### SUMMARY OF THE INVENTION

The present invention generally provides methods, apparatus and articles of manufacture for joining nodes to a cluster.

According to one embodiment of the invention, a method for joining a plurality of nodes to a cluster includes receiving a first start request from a first node, where the first start request includes a request to join the first node to the cluster, wherein the cluster comprises a first sponsor node and a second sponsor node, and wherein each node in the cluster maintains a respective membership list identifying each active member node of the cluster, and the first node is sponsored by the first sponsor node. After receiving the first start request and before joining the first node to the cluster, a second start request is received from a second node where the second start request includes a request to join the second node to the cluster, wherein the second node is sponsored by the second sponsor node. Membership change messaging is managed relative to the first and second start requests to ensure that the first node is added to the respective membership lists before broadcasting a membership change message (MCM) in response to which, the nodes of the cluster, inclusive of the first node, add the second node to the respective membership lists.

According to one embodiment of the invention, a computer readable storage medium contains a program which, when executed by a processor includes receiving a first start request from a first node including a request to join the first node to the cluster, wherein the cluster includes a first sponsor node and a second sponsor node, and wherein each node in the cluster maintains a respective membership list identifying each active member node of the cluster, and the first node is sponsored by the first sponsor node. After receiving the first start request and before joining the first node to the cluster, a second start request is received from a second node including a request to join the second node to the cluster, wherein the second node is sponsored by the second sponsor node. Membership change messaging is managed relative to the first and second start requests to ensure that the first node is added to the respective membership lists before broadcasting a membership change message (MCM) in response to which, the nodes of the cluster, inclusive of the first node, add the second node to the respective membership lists.

According to one embodiment of the invention, a system includes one or more nodes, each including a processor and a group services manager which, when executed by the processor, is configured to receive a first start request from a first node including a request to join the first node to the cluster, wherein the cluster includes a first sponsor node and a second sponsor node, and wherein each node in the cluster maintains a respective membership list identifying each active member node of the cluster, and the first node is sponsored by the first sponsor node. After receiving the first start request and before joining the first node to the cluster, a second start request is received from a second node including a request to join the second node to the cluster, wherein the second node is sponsored by the second sponsor node. Membership change messaging is managed relative to the first and second start requests to ensure that the first node is added to the respective membership lists before broadcasting a membership change message (MCM) in response to which, the nodes of the cluster, inclusive of the first node, add the second node to the respective membership lists.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1A is a block diagram of nodes before a concurrent node self-start for a peer cluster, according to one embodiment of the invention.

FIG. 1B illustrates the peer cluster after the concurrently self-starting nodes join the cluster, according to one embodiment of the invention.

FIG. 2 is a block diagram of a node in a peer cluster, according to one embodiment of the invention.

FIG. 3 is a flow chart of a process for concurrent node self-start in a peer cluster, according to one embodiment of the invention.

FIG. 4A illustrates the message reception process, according to one embodiment of the invention.

FIG. 4B illustrates the message management process, according to one embodiment of the invention.

FIG. 5 is a message flow diagram of an example concurrent node self-start of nodes in a peer cluster, according to one embodiment of the invention.

FIG. 6 is a state diagram of nodes in a peer cluster during a concurrent node self-start, according to one embodiment of the invention.

### DETAILED DESCRIPTION OF THE PREFERRED EMBODIMENTS

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; (ii) writable storage media (e.g., floppy disks within a diskette drive, a hard-disk drive, random access memory, etc.) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

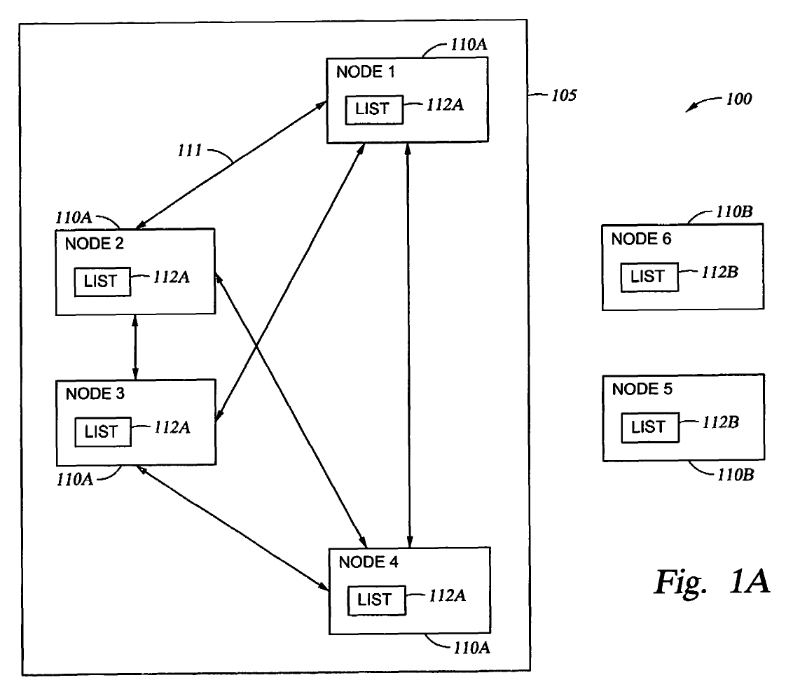

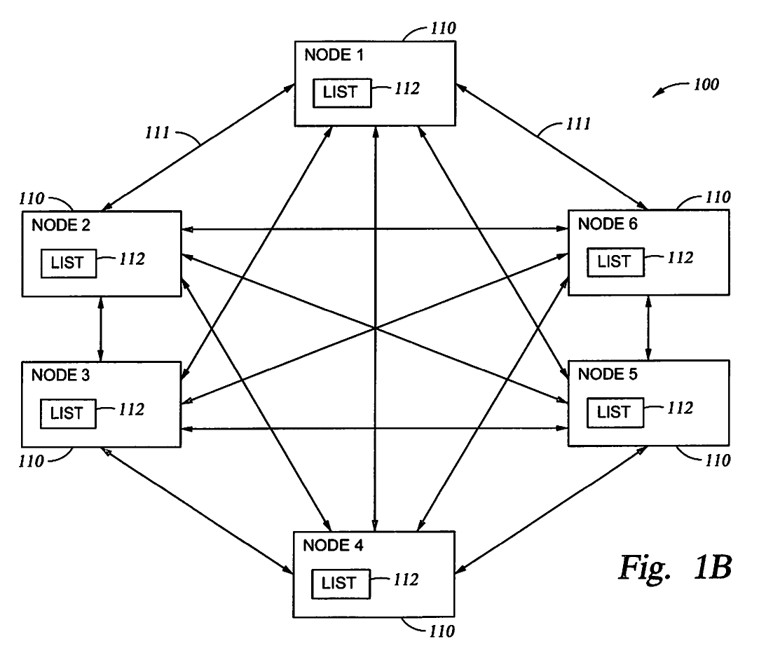

FIG. 1A is a block diagram of nodes 110 before a concurrent node self-start for a peer cluster 105, according to one embodiment of the invention. Nodes 110 include active cluster nodes 110A, and concurrently self-starting nodes 110B (collectively referred to as nodes 110). Each node 110 may be, for instance, an eServer iSeries® computer available from International Business Machines, Inc., of Armonk, N.Y. Active peer cluster 105 contains clustered nodes 110A interconnected with one another via a network of cluster communication pathways 111. Any number of network topologies commonly used in clustered computer systems may be used consistent with the invention. Moreover, individual nodes 110 may be physically located in close proximity with other nodes 110, or may be geographically separated across cluster communication pathways 111. Some examples of networks of communication pathways 111, consistent with embodiments of the invention are local area networks, wide area networks, and the Internet.

Connecting nodes 110A typically requires networking software, which generally operates according to a protocol for exchanging information. Transmission control protocol, internet protocol (TCP/IP) is an example of one protocol that may be used to an advantage.

According to one embodiment of the invention, each node 110 contains a cluster membership list 112 that represents the respective node's view of peer cluster membership. The cluster communication pathways 111 represent the entries of all active cluster nodes in each node's membership list. For example, node 1 has a communication pathway 111 to each of nodes 2, 3, and 4. Accordingly, in addition to an active entry in membership list 112A for the node 1 itself, there are three active entries for nodes 2, 3, and 4, respectively. Further, because there are no communication pathways 111 for nodes 5 and 6, their respective membership lists 112B are limited to one active entry for the node 110B that the membership list 112B resides on. In other words, the membership list 112B for Node 5 contains only one active entry, i.e. an entry for itself (Node 5); likewise, the membership list 112B for Node 6 contains only an active entry for itself. In order to grow a cluster 105, active nodes 110A send start requests and membership change messages (MCMs) across the cluster communication pathways 111 to join self-starting nodes 110B to the peer cluster 105.

FIG. 1B illustrates the peer cluster 105 after the concurrently self-starting nodes 110B join the cluster 105, according to one embodiment of the invention. As is shown in FIG. 1B, communication pathways 111 exist for each node 110 to every other node 110 in the cluster 105. Accordingly, each membership list 112 illustrated in FIG. 1B contains entries for all six nodes 110 in the cluster 105. Thus, the “view” of the cluster 100 is the same from the perspective of each node in the cluster.

In order to join concurrently self-starting nodes 110B to a cluster, the sponsor node may direct all the active nodes 110A of a cluster 105 to add the self-starting node 110B to the active nodes' membership lists 112A. Joining concurrently self-starting nodes 110B to a peer cluster may be problematic if the self-starting nodes 110B have distinct sponsor nodes 110A. The larger the cluster 105, the more likely that each of self-starting nodes 110B, finds a different sponsor node 110A during node discovery. According to one embodiment of the invention, a node 110B joins a peer cluster 105 by submitting start requests to its respective sponsor node 110A. When two or more distinct nodes 110B each submit start requests to distinct sponsor node 110A, the sponsor nodes 110A do not necessarily know of the pending start requests on the other sponsor nodes 110A. Hence, after joining all the self-starting nodes 110B to peer cluster 105, each self-starting node 110B may not contain the other self-starting nodes 110B in its respective membership list 112B. Accordingly, the node 110Bs' view of the cluster 105 may differ and there is no single system image.

For example, referring again to FIG. 1A, nodes 5 and 6 may find nodes 1 and 2, respectively, as their sponsor nodes 110A. In order to join cluster 105, nodes 5 and 6 may send start request to their sponsor nodes 1 and 2, respectively. If node 5 is unaware of the start request on node 6, node 1 starts node 5 without instructing node 5 to include node 6 in its membership list 112B. Similarly, if node 6 is not aware of the start request on node 5, node 2 starts node 6 without instructing node 6 to include node 5 in its membership list 112B. Because the membership lists 112 are not uniform across peer cluster 105, there is no single system image. Nodes 1-4 see nodes 1-6 as members of peer cluster 105. In contrast, node 5 sees nodes 1-5 in its membership list 112, and node 6 sees nodes 1-4, and node 6 in its membership list 112.

According to one embodiment of the invention, concurrent node self-start manages MCMs to ensure that when distinct nodes 110A sponsor distinct self-starting nodes 110B, the membership lists 112 are uniform for every member node 110 of the peer cluster 105, thereby maintaining the single system image.

The distributed environments of FIG. 1A-B are only two examples of peer clusters. It is possible to include more or fewer nodes. Further, the nodes 110 do not have to be eServer iSeries® computers. Some or all of the nodes 110 can include different types of computers and different operating systems.

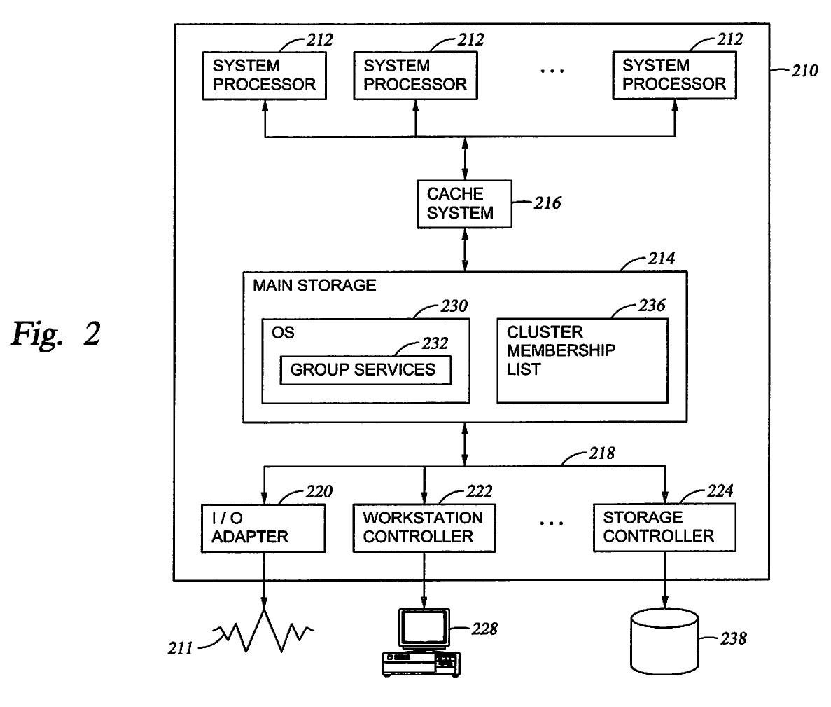

FIG. 2 is a block diagram of a node 210 in a peer cluster 105, according to one embodiment of the invention. Node 210 generically represents, for example, any of a number of multi-user computers such as a network server, a midrange computer, a mainframe computer, etc. However, it should be appreciated that the invention may be implemented in other computers and data processing systems, e.g., in stand-alone or single-user computers such as workstations, desktop computers, portable computers, and the like, or in other programmable electronic devices (e.g., incorporating embedded controllers and the like).

Node 210 generally includes one or more system processors 212 coupled to a main storage 214 through one or more levels of cache memory disposed within a cache system 216. Furthermore, main storage 214 is coupled to a number of types of external devices via a system input/output (I/O) bus 218 and a plurality of interface devices, e.g., an input/output adaptor 220, a workstation controller 222 and a storage controller 224, which respectively provide external access to one or more external networks 211 (e.g., a cluster network 111), one or more workstations 228, and/or one or more storage devices such as a direct access storage device (DASD) 238. Any number of alternate computer architectures may be used in the alternative.

To implement self-starting node functionality consistent with the invention, each node 210 requesting to be joined to a cluster typically includes a clustering infrastructure to manage the clustering-related operations on the node. For example, node 210 is illustrated as having resident in main storage 214 an operating system 230 implementing a clustering infrastructure referred to as group services 232. Group services 232 assists in managing clustering functionality on behalf of the node and is responsible for delivering messages through the network 211 such that all nodes 210 receive all messages in the same order. It will be appreciated, however, that the functionality described herein may be implemented in other layers of software in node 210, and that the functionality may be allocated among other programs, computers or components in a peer cluster, such as peer cluster 105 described in FIG. 1A. Therefore, the invention is not limited to any particular software implementation.

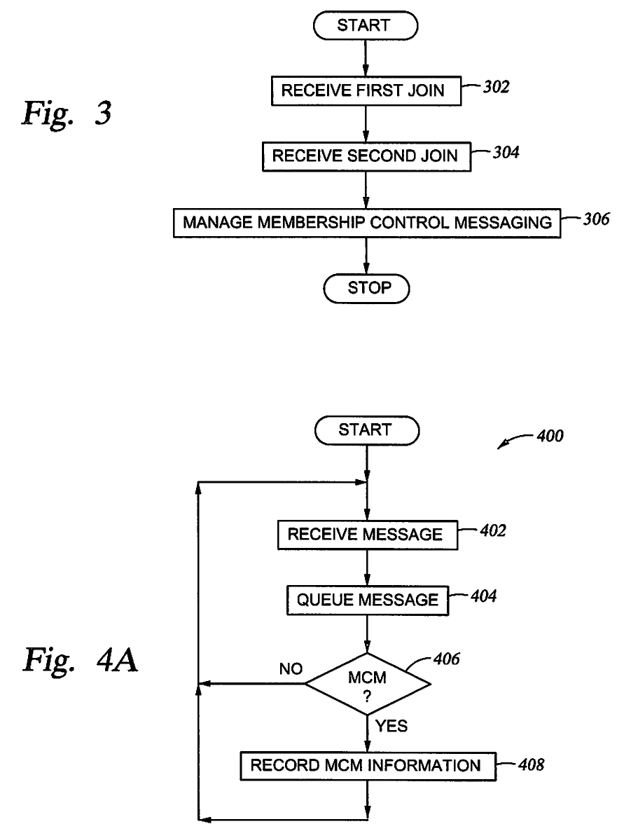

FIG. 3 is a flow chart 300 of a process for concurrent node self-start in a peer cluster 105, according to one embodiment of the invention. At step 302, an active node 110A of a peer cluster (such as node 2 of the peer cluster 105 described in FIG. 1A) receives a start request for a self-starting node (such as node 5 described in FIG. 1A).

At step 304, (before node 5 joins peer cluster 105) the node 2 receives a second start request for a second self-starting node (such as node 6 described in FIG. 1A). Node 2 queues the second start request until node 2 completes processing the first start request for node 5.

The active nodes 110A of a peer cluster 105 automatically send membership change messages (MCMs) when a self-starting node 110B joins the peer cluster 105. In order to ensure that all concurrently self-starting nodes 110B know of each other when joining the peer cluster 105, the active nodes 110A process the MCM of a first start request before processing the MCM of a second start request.

Accordingly, at step 306, the node 2 manages MCMs relative to the first and second start requests to ensure that node 5 is added to the respective membership lists 112A on all active cluster nodes 110A, i.e., nodes 1-4, before broadcasting an MCM in response to which, the nodes of the cluster 110A, inclusive of the first node, add the self-starting node 6 to the respective membership lists.

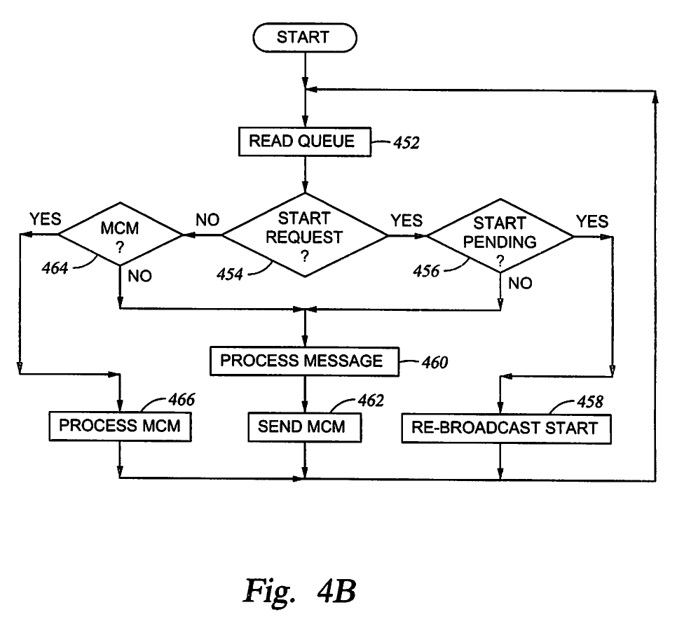

Although FIG. 3 appears to illustrate one sequential process, the process may be two distinct processes running concurrently on each active node 110A: a message reception process and a message management process. FIG. 4A illustrates the message reception process, according to one embodiment of the invention. FIG. 4B illustrates the message management process, according to one embodiment of the invention.

FIG. 4A includes reception of all message types, including the MCMs and the start requests described in FIG. 3. At step 402, an active node 110A receives a message. Each node 110 maintains a message queue; accordingly, at step 404, the node 110A queues the received messages.

At step 406, the node 110A checks each message in its respective queue to determine whether the message is an MCM. For each received message that is not an MCM, control flow returns to step 402. If the message is an MCM, at step 408, the node 110A stores data indicating when the new MCM is received relative to preceding and subsequent start requests. The MCM message remains on the queue.

FIG. 4B illustrates message managing for all message types as the active nodes 110A read their respective queues. At step 452, the node 110A reads the message queue. At step 454, the node 110A determines whether the message is a start request (referred to as a “current start request”).

If the message read from the queue is a current start request then, at step 456, the node 110A determines whether another start request is currently pending (referred to as the “pending start request”). In one embodiment, the node 110A determines whether another start request is currently pending by checking when the associated MCM is received relative to the current start request. If the MCM is received after the current start request, the associated MCM is not processed and another start request is pending. Conversely, if the MCM is received before the current start request, the MCM is processed and no start request is pending.

If a start request is pending, at step 458, the current start request just read off of the message queue (at step 452) is canceled and re-broadcast. A pending start request indicates that node 110A received the current start request (i.e., the start request read at step 452) before processing the MCM for the pending start request. Group services 232 ensures that all active nodes receive messages broadcast to the entire cluster 105, in the same order. Because the node 110A did not process the MCM for the pending start request before receiving the current start request, the self-starting node 110B of the pending start request could not have received the current start request. Re-broadcasting the current start request ensures that the self-starting node 110B of the pending start request receives the current start request. According to one embodiment of the invention, only the sponsor node re-broadcasts the current start request. In another embodiment of the invention, the lowest named (i.e., lowest or first, alphabetically) active node re-broadcasts the second start request. According to embodiments of the invention, only one node 110A need re-broadcast the current start request.

If a start request is not pending, at step 460, the node 110A processes the current start request. Processing the current start request includes updating the membership list 112A. At step 462, group services 232 sends an MCM for the current start request.

If, at step 454, the node 110A determines that the message just read off of the message queue is not a start request, then at step 464, the node 110A determines whether the message is an MCM. If not, control passes to step 460 where processing appropriate to the message type is performed.

If the message is an MCM, then at step 466, the node 110A processes the MCM. Processing the MCM includes actually joining the self-starting node 110A to the peer cluster 105.

Advantageously, by determining whether an active node 110A receives a new start request before the MCM for a pending start request, it is possible to ensure that newly joined nodes receive start requests for concurrently self-starting nodes.

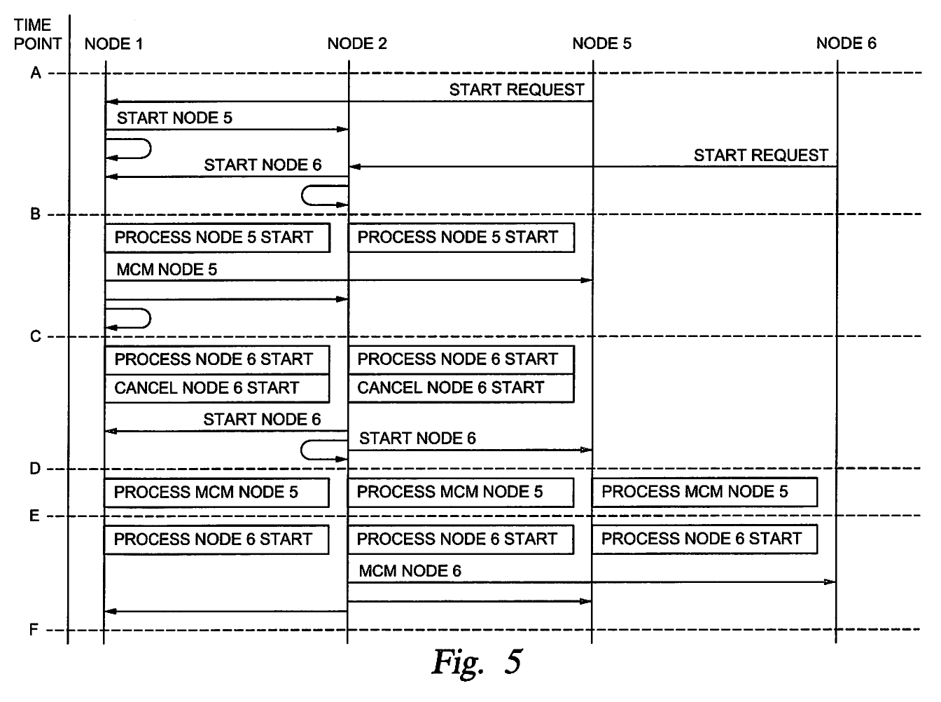

FIG. 5 is a message flow diagram of an example concurrent node self-start of the nodes 5 and 6, in a peer cluster 105, according to one embodiment of the invention. For the purposes of this example, nodes 1 and 2 sponsor nodes 5 and 6, respectively. Nodes 3 and 4 are not discussed for the sake of clarity; however, nodes 3 and 4 behave according to the following description of nodes 1 and 2, with exception to nodes 1 and 2's sponsor-related behavior.

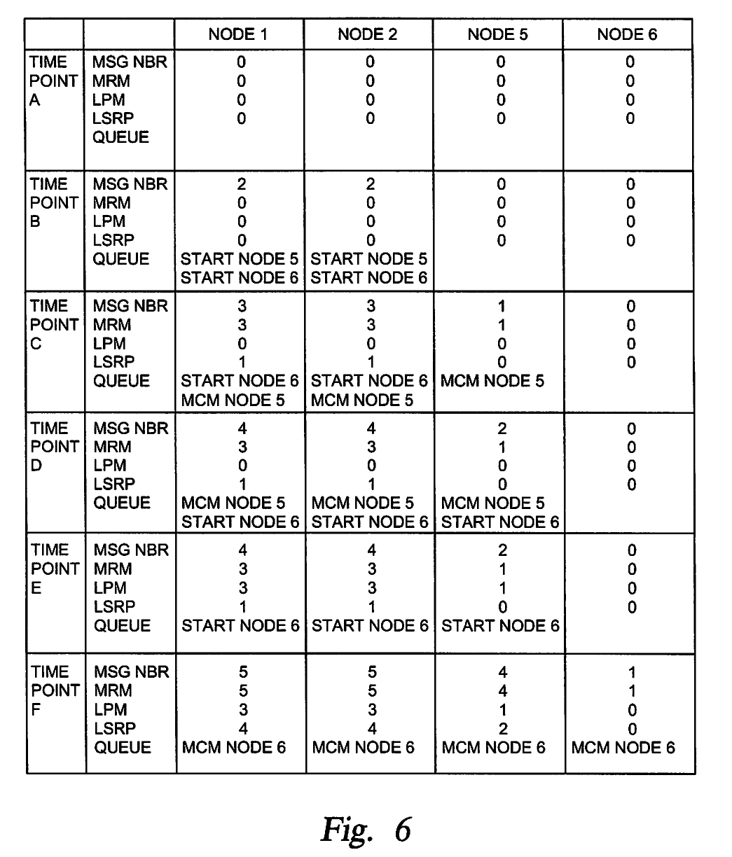

FIG. 6 is a state diagram of nodes 1, 2, 5 and 6 in a peer cluster 105 during concurrent node self-start for nodes 5 and 6, according to one embodiment of the invention. The letters A-F in the time point columns of FIGS. 5 and 6 represent chronologically occurring time points for the nodes 1, 2, 5, and 6. At each time point, A-F illustrated in FIG. 5, FIG. 6 illustrates a current message number (MSG NBR), a most recently received MCM number (MRM), a last processed MCM number (LPM), a last start request processed number (LSRP) and the message queue contents (QUEUE) for each node 1, 2, 5, and 6.

According to one embodiment of the invention, the MSG NBR is an incrementing value, indicating the number of the most recently received message at a particular node 110. Every time a node 110 receives a message to be queued, whether an MCM or a start request, the MSG NBR is incremented by 1 and assigned to the received message.

According to one embodiment of the invention, the MRM and LPM values allow a node 110 to determine whether the node 110 receives a second start request while another start request is pending, as described in step 406 of FIG. 4B.

The MRM indicates the MSG NBR of the most recently received MCM. The nodes 110 record the MRM as MCMs are received, not when the node 110 processes the MCM. The nodes 110 record the LPM as the MCMs are processed.

By comparing the MRM to the LPM, it is possible to determine whether a start request is pending. For example, when node 1 receives an MCM message, node 1 may increment MSG NBR to 1, and stores a 1 in the MRM. After node 1 processes the message number 1 MCM, node 1 records a 1 in LPM. There may be a time window during which an MCM sits in the node's 110 queue. During that window, the MCM and LPM are unequal, indicating that a start request is pending.

According to one embodiment of the invention, a node 110 may begin to process a second start request before the node 110 receives the MCM for a pending start request. In such a scenario, the node 110 may determine whether a start request is pending by comparing the LSRP to the MRM.

For example, node 2 may receive start requests for nodes 5 and 6, and assign MSG NBRs of 1 and 2, respectively. After processing node 5, node 2 updates the LSRP to 1 (the MSG NBR of the start request for node 5). If node 2 begins processing the start request for node 6 before the MCM for node 5 arrives, the MRM and the LPM are equal (both equal 0), even though a start request is pending. By determining that the LSRP (=1) is not equal to the MRM (=0), the node 2 knows that a start request is pending and re-broadcasts the second start request, as described in step 408 of FIG. 4B.

Time point A on FIGS. 5 and 6 represent the time before the concurrent node self-start begins. As is shown in FIG. 6, at time point A, all message number values are zero, and the queues are empty for all the nodes 1, 2, 5, and 6.

As is shown in FIG. 5, node 5 sends a start request to its sponsor node 1. After receiving the start request, node 1 performs some security verification and sends ‘Start Node 5’ messages to all active members of the peer cluster, including itself and node 2.

Similarly, node 6 sends a start request to its sponsor node 2. After receiving the start request, node 2 performs some security verification and sends ‘Start Node 6’ messages to all active members of the peer cluster, including itself and node 1. Although nodes 5 and 6 may send the start requests concurrently, a sequence is described here for the sake of clarity.

As is shown in FIG. 5, after the start requests are received, the process is at time point B. Because nodes 1 and 2 have both received two messages, at time point B, FIG. 6 shows that the MSG NBR is 2 for both nodes 1 and 2. Further, each queue for nodes 1 and 2 contains the ‘start node 5’ and the ‘start node 6’ requests. FIGS. 5 and 6 illustrate the start node 5 request preceding the start node 6 request even though in a concurrent node self-start, the requests are received concurrently. However, group services 232 arbitrarily sequences the start request messages. Accordingly, there is no loss of generality by having the node 5 request ordered first.

As is shown in FIG. 5, the nodes 1 and 2 then process the ‘start node 5’ requests. Processing the ‘start node 5’ requests includes the processing described in FIG. 4B. First, the nodes 1 and 2 read their respective queues, as described in step 402. The first message in each queue, as shown in FIG. 6, is the ‘start node 5’ request. The nodes 1 and 2 then determine whether the message is a start request, as described in step 404.

Because the current message is a start request, the nodes 1 and 2 then determine whether another start request is pending, as described in step 406. As is shown in FIG. 6 (at time point B), the MRM and LPM values are equal (both equal zero). Further, the LSRP equals the MRM. Accordingly, the nodes 1 and 2 determine that another start request is not pending.

The nodes 1 and 2 then process the ‘start node 5’ request, as described in step 410, and further including setting the LSRP for each node 1 and 2 to one (the message number of the start request for node 5). The node 1 then sends an MCM for node 5 to nodes 1, 2, and 5, as described in step 412.

As is shown in FIG. 5, the process is now at time point C. Because nodes 1, 2, and 5 have received the MCM message for node 5, FIG. 6 shows that, at time point C, the MSG NBR for nodes 1 and 2 is ‘3,’ and for node 5 is ‘1.’ As is further shown in FIG. 6, the nodes 1 and 2 assign MSG NBR, ‘3’ to the MRM, and node 5 assigns its MSG NBR, ‘1’ to node 5's respective MRM.

Finally, the queues for nodes 1 and 2 no longer contain the start request for node 5. However, nodes 1, 2, and 5 contain the MCM for node 5 at time point C.

However, before the MCM is processed, nodes 1 and 2 read their respective queues and attempt to process the start request for node 6. Because the message is a start request (determined at step 404), the nodes then determine whether another start request is pending. This is done by comparing the MRM and the LPM of nodes 1 and 2, and comparing the LSRP and the MRM of nodes 1 and 2.

As is shown in FIG. 6 (at time point C), in each of nodes 1 and 2, the MRM does not equal the LPM. Further, the LSRP does not equal the MRM. Accordingly, nodes 1 and 2 determine that another start request is pending.

As shown in FIG. 5 (at time point C) and described in step 408, nodes 1 and 2 then cancel the start request for node 6. According to one embodiment of the invention, node 6's sponsor, node 2, re-broadcasts the start request for node 6. The re-broadcast includes sending the ‘start node 6’ request to the currently self-starting node 5, as is shown in FIG. 5.

As is also shown in FIG. 5, the process is now at time point D, when FIG. 6 illustrates that the MSG NBRs and the QUEUEs for nodes 1, 2, and 5 are changed relative to time point C. Specifically, the MSG NBRs are incremented because nodes 1, 2, and 5 have received another start request for node 6. Further, nodes 1 and 2 cancel the original node 6 start request from their respective QUEUEs. Node 2 then re-broadcasts the start request for node 6, which is shown in the respective QUEUEs ordered behind the MCM for node 5.

Referring back to FIG. 5, nodes 1, 2, and 5 process the next message in their respective QUEUEs, the MCM for node 5. Processing the MCM finalizes joining node 5 to peer cluster 105. Node 5 is now an active node 110A of peer cluster 105. Processing the MCM also includes updating the LPM on nodes 1, 2, and 5. The new values are shown in FIG. 6 at time point E. The nodes set the LPM values to the MSG NBRs of the MCMs processed in nodes 1, 2 and 5.

After processing the MCM for node 5, nodes 1, 2, and 5 then read their respective queues, and start processing the start request for node 6. Because the LPM equals the MRM in each of nodes 1, 2, and 5, the nodes 1, 2, and 5 determine that there is not another start request pending. Accordingly, the node 2 sends an MCM for node 6 to nodes 1, 2, 5, and 6, and nodes 1, 2, 5, and 6 update their MSG NBR and MRM values. The process is now at time point F.

In FIG. 6, time point F shows MRMs of 5, 5, 4, and 1, respectively in nodes 1, 2, 5, and 6. Appropriately, the MRMs are not equal to their respective LPMs because there is a start request pending for node 6.

Advantageously, embodiments of the invention may use message ordering and MCMs to determine whether start requests are pending before a new start request is processed. Enabling the nodes 110A of a peer cluster to determine whether start requests are pending facilitates concurrent node self-starts such that the single system image is properly maintained.

While the foregoing is directed to embodiments of the present invention, other and further embodiments of the invention may be devised without departing from the basic scope thereof, and the scope thereof is determined by the claims that follow.

What is claimed is:

1. A method of joining a plurality of nodes to a cluster, the method comprising:
receiving a first start request from a first node comprising a request to join the first node to the cluster, wherein:
the cluster comprises a first sponsor node and a second sponsor node, and wherein each node in the cluster maintains a respective membership list identifying each active member node of the cluster; and
the first node is sponsored by the first sponsor node;
after receiving the first start request and before joining the first node to the cluster, receiving a second start request from a second node comprising a request to join the second node to the cluster, wherein the second node is sponsored by the second sponsor node; and
managing membership change messaging relative to the first and second start requests to ensure that the first node is added to the respective membership lists before broadcasting a membership change message (MCM) in response to which, the nodes of the cluster, inclusive of the first node, add the second node to the respective membership lists.

2. The method of claim 1, wherein the first sponsor node receives the first and second start requests, and the MCM; and
managing membership change messaging comprises:
determining that the first sponsor node receives the second start request before joining the first node to the cluster;
canceling the second start request; and
re-broadcasting the second start request to the first and second sponsor nodes, and the first node.

3. The method of claim 2, wherein the second sponsor node re-broadcasts the second start request.

4. The method of claim 2, wherein a lowest named active node re-broadcasts the second start request, wherein the lowest named active node comprises a first member of the cluster.

5. The method of claim 2, wherein:
upon receiving a first MCM associated with the first node, the first sponsor node stores a last received MCM value (LRM), wherein the LRM is based on a message number, wherein the message number is an integer value that the first sponsor node increments upon receiving a message;
upon processing the second start request, determining that the LRM value is greater than a last processed MCM value (LPM), indicating that the first sponsor node receives the second start request before joining the first node to the cluster; and
upon processing the first MCM, the first sponsor node stores a first LPM value, wherein the first LPM value equals the LRM value.

6. The method of claim 2, wherein:
upon receiving a first MCM associated with the first node, the first sponsor node stores a last received MCM value (LRM), wherein the LRM value is based on a message number, wherein the message number is an integer value that the first sponsor node increments upon receiving a message, and the LRM value equals the message number when the first MCM is received;
upon processing the first MCM, the first sponsor node stores a last processed MCM value (LPM), wherein the LPM value equals the message number when the first LCM is received;
upon processing the first start request, the first sponsor node stores a last processed start request value (LPSR), wherein the LPSR value indicates the order in which the first sponsor node receives the first start request; and
upon processing the second start request, determining that the LRM value equals the LPM value, and that the LPSR value is greater than the LRM value, indicating that the first sponsor node receives the second start request before joining the first node to the cluster.

7. The method of claim 6, wherein the second sponsor node re-broadcasts the second start request.

8. The method of claim 6, wherein a lowest named active node re-broadcasts the second start request, wherein the lowest named active node comprises a first member of the cluster.

9. The method of claim 1, wherein the cluster is a grid computer.

10. A computer readable storage medium containing a program which, when executed by a process, performs an operation comprising:
receiving a first start request from a first node comprising a request to join the first node to the cluster, wherein:
the cluster comprises a first sponsor node and a second sponsor node, and wherein each node in the cluster maintains a respective membership list identifying each active member node of the cluster; and
the first node is sponsored by the first sponsor node;
after receiving the first start request and before joining the first node to the cluster, receiving a second start request from a second node comprising a request to join the second node to the cluster, wherein the second node is sponsored by the second sponsor node; and
managing membership change messaging relative to the first and second start requests to ensure that the first node is added to the respective membership lists before broadcasting a membership change message (MCM) in response to which, the nodes of the cluster, inclusive of the first node, add the second node to the respective membership lists.

11. The computer readable storage medium of claim 10, wherein the first sponsor node receives the first and second start requests, and the MCM; and
managing membership change messaging comprises:
determining whether the first sponsor node receives the second start request before receiving the MCM; and if so
canceling the second start request; and
re-broadcasting the second start request to the first and second sponsor nodes, and the first node.

12. The computer readable storage medium of claim 11, wherein the second sponsor node re-broadcasts the second start request.

13. The computer readable storage medium of claim 11, wherein a lowest named active node re-broadcasts the second start request, wherein the lowest named active node comprises a first member of the cluster.

14. The computer readable storage medium of claim 11, wherein:
upon receiving a first MCM associated with the first node, the first sponsor node stores a last received MCM value (LRM), wherein the LRM value is based on a message number, wherein the message number is an integer value that the first sponsor node increments upon receiving a message, and the LRM value equals the message number when the first MCM is received;
upon processing the second start request, determining that the LRM value is greater than a last processed MCM value (LPM), wherein the LPM value equals the message number when the MCM is received;
indicating that the first sponsor node receives the second start request before joining the first node to the cluster; and
upon processing the first MCM, the first sponsor node stores a first LPM value, wherein the first LPM value equals the LRM value.

15. The computer readable storage medium of claim 11, wherein:
upon receiving a first MCM associated with the first node, the first sponsor node stores a last received MCM value (LRM), wherein the LRM value is based on a message number, wherein the message number is an integer value that the first sponsor node increments upon receiving a message, and the LRM value equals the message number when the first MCM is received;
upon processing the first MCM, storing a last processed MCM value (LPM), wherein the LPM value equals the message number when the MCM is received;
upon processing the first start request, the first sponsor node stores a last processed start request value (LPSR), wherein the LPSR value indicates the order in which the first sponsor node receives the first start request; and
upon processing the second start request, determining that the LRM value equals the LPM value, and that the LPSR value is greater than the LRM value, indicating that the first sponsor node receives the second start request before joining the first node to the cluster.

16. The computer readable storage medium of claim 15, wherein the second sponsor node re-broadcasts the second start request.

17. The computer readable storage medium of claim 15, wherein a lowest named active node re-broadcasts the second start request, wherein the lowest named active node comprises a first member of the cluster.

18. The computer readable storage medium of claim 10, wherein the cluster is a grid computer.

19. A system, comprising:
one or more nodes, each comprising a processor and a group services manager which, when executed by the processor, is configured to:
receive a first start request from a first node comprising a request to join the first node to the cluster, wherein:
the cluster comprises a first sponsor node and a second sponsor node, and wherein each node in the cluster maintains a respective membership list identifying each active member node of the cluster; and
the first node is sponsored by the first sponsor node;
after receiving the first start request and before joining the first node to the cluster, receiving a second start request from a second node comprising a request to join the second node to the cluster, wherein the second node is sponsored by the second sponsor node; and
manage membership change messaging relative to the first and second start requests to ensure that the first node is added to the respective membership lists before broadcasting a membership change message (MCM) in response to which, the nodes of the cluster, inclusive of the first node, add the second node to the respective membership lists.

20. The system of claim 1, wherein the group services manager is further configured to:
manage membership change messaging comprises determining whether the first sponsor node receives the second start request before joining the first node to the cluster;
cancel the second start request; and
re-broadcast the second start request to the first and second sponsor nodes, and the first node, wherein the second sponsor node re-broadcasts the second start request.
